(19) United States
(12) Patent Application Publication
(10) Pub. No.: US 2023/0376215 A1
(43) Pub. Date: Nov. 23, 2023

(54) MULTI-DECK NAND MEMORY WITH HYBRID DECK SLC

(71) Applicant: Intel NDTM US LLC, Santa Clara, CA (US)

(72) Inventors: Aliasgar S Madraswala, Folsom, CA (US); Xin Sun, Fremont, CA (US); Naveen Prabhu Vittal Prabhu, Folsom, CA (US); Sagar Upadhyay, Folsom, CA (US)

(73) Assignee: Intel NDTM US LLC, Santa Clara, CA (US)

(21) Appl. No.: 18/086,315

(22) Filed: Dec. 21, 2022

(51) Int. Cl. G06F 3/06

(52) U.S. Cl. CPC G06F 3/0619; G06F 3/064; G06F 3/0679; G06F 3/0634

(57) ABSTRACT

An example of a memory device may comprise NAND media with a plurality of decks, and circuitry coupled to the NAND media to control access to a superblock of memory cells aligned along a pillar of the NAND media, wherein the superblock includes at least a first block that corresponds to memory cells aligned along the pillar in a first deck of the plurality of decks and a second block that corresponds to memory cells aligned along the pillar in a second deck of the plurality of decks, configure the NAND media in a first program mode for the first block of the superblock, and configure the NAND media in a second program mode for the second block of the superblock. Other examples are disclosed and claimed.

### BACKGROUND

A typical flash memory device may include a memory array that includes a large number of non-volatile memory cells arranged in row and column fashion. In recent years, vertical memory, such as three-dimensional (3D) memory, has been developed in various forms, such as NAND, cross-point, or the like. A 3D flash memory array may include a plurality of memory cells stacked over one another to form a vertical NAND string. With an increased number of tiers in 3D NAND, and increased block size, the minimum data unit that can be erased at once also increases. To reduce the block size, some 3D NAND memory devices may utilize a block-by-deck (BBD) architecture. In an example BBD architecture, the tiers are divided into 3 decks, with 48 write-lines (WLs) in each deck, and the block size is reduced from 144 MB to 48 MB.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of a memory device according to an example;

FIG. 2 is a block diagram of a system according to an example;

FIGS. 3A to 3D are an illustrative diagram of a method according to an example;

FIGS. 4A to 4C are illustrative diagrams of a memory device according to an example;

FIG. 5 is an illustrative diagram of a table of parameters for a vendor specific command according to an example;

FIG. 6 is a block diagram of an example of a computing system according to an example; and

FIG. 7 is a block diagram of an example of a storage device according to an example.

### DETAILED DESCRIPTION

One or more examples or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, Field Programmable Gate Array (FPGA), firmware, driver, software, or any combination thereof. The material disclosed herein may also be implemented as instructions stored on a machine-readable medium, which may be read and executed by Moore Machine, Mealy Machine, and/or one or more processors. A machine-readable medium may include any medium and/or mechanism for storing or transmitting information in a form readable by a machine (e.g., a computing device). For example, a machine-readable medium may include read only memory (ROM); random access memory (RAM); Dynamic random-access memory (DRAM), magnetic disk storage media; optical storage media; NV memory devices; phase-change memory, qubit solid-state quantum memory, electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every example may not necessarily include the particular feature, structure, or characteristic. Moreover, such phrases are not necessarily referring to the same implementation. Further, when a particular feature, structure, or characteristic is described in connection with an example, it is submitted that it is within the knowledge of one skilled in the art to effect such feature, structure, or characteristic in connection with other implementations whether or not explicitly described herein.

NV memory (NVM) may be a storage medium that does not require power to maintain the state of data stored by the medium. In one example, the memory device may include a three-dimensional (3D) NAND or similar device. The memory device may refer to the die itself and/or to a packaged memory product. In particular examples, a memory component with non-volatile memory may comply with one or more standards promulgated by the JEDEC, or other suitable standard (the JEDEC standards cited herein are available at jedec.org).

In a 3D memory device, a “deck” of a memory array may refer to a portion of a physical memory array that includes a subset of its memory cells. By applying bias voltages to different physical wordlines of a memory block in different combinations, a memory array may be divided into two, three, four, or more logical decks, each of which may be treated as independent. A block-by-deck (BBD) operation of the memory array may refer to operating at the deck level, and not on the whole memory array, or memory block, at one time.

For example, a floating gate 3D NAND memory array may utilize a multiple deck architecture (e.g., two deck, three deck, and so on), where each block may be composed of multiple vertically stacked decks separated by an interfacial region (e.g., a polysilicon plug). In some examples, in this physical array architecture, algorithms to program, erase, and read the memory array may be used by the controller so that each deck may operate as an independent block. In this manner, the block size may be effectively reduced by K times, where the total number of decks in the device is K (e.g., where K may be 2, 3 or some greater integer). In some example, the technology described herein may allow each deck to operate independently without disturbing the other decks.

A problem is that reading memory cells in one deck of a superblock or block in the memory device after an operation has been performed on another deck in the same superblock or block may result in enhanced hot carrier injection (HCI) read disturb. The above may for example result after operations on individual decks in a block-by-deck (BBD) architecture of 3D NAND memory devices and may be exacerbated if the individual decks of a block have mixed program levels.

Some NAND-based storage systems (e.g. a solid-state drive (SSD) system) may reserve certain NAND blocks in a single-level cell (SLC) mode to store system specific information (e.g., fast/slow context, power loss imminent (PLI), etc.). As NAND memory technology improves and more tiers and subblocks are implemented, the storage capacity of a NAND block may increase. The system-information storage requirements may not increase with the same magnitude, however, potentially leaving a portion of system-reserved NAND blocks unutilized. One approach to the utilization problem includes technology that allows the storage system to treat each deck as a virtual block for all storage applications (e.g., true-block-by-deck technology). A problem is that all decks of the system-reserved block(s) for system-information storage are programmed in the same mode (e.g., either SLC or a native mode such as a multi-level cell (MLC), tri-level cell (TLC), quad-level cell (QLC), penta-level cell (PLC), etc.), potentially still leaving the unused decks of system-reserved blocks unutilized or under-utilized because the system-reserved blocks are used in SLC mode. For example, MLC natively stores two bits per cell, TLC natively stores three bits per cell, QLC natively stores four bits per cell, and PLC natively stores five bits per cell. Native mode may refer to the number of levels that the memory cell is physically designed to support (e.g., native mode is MLC mode for MLC, TLC mode for TLC, QLC mode for QLC, PLC mode for PLC, and so on).

The problem may be further exacerbated when the system detects a defect on a block that is reserved to be used in SLC mode for system-specific-applications. In that case, the system may identify another available block that can be repurposed to be used for system-applications. A problem is that converting all decks of the available block from native mode to SLC mode affects the storage capacity of the NAND. Some examples may overcome one or more of the foregoing problems.

Some examples may provide technology for a hybrid deck SLC NAND memory configuration. In some examples, hybrid deck SLC technology may allow a storage system to have one deck of multiple decks of a NAND memory device that the storage system plans to use for system-specific-information storage in SLC mode while the other decks of the multiple decks may be in native mode (e.g., TLC/QLC/PLC mode) to be used for other data storage. Some examples of hybrid deck SLC technology may support a set of NAND policies that allows a storage system to have any one deck of a targeted block in SLC mode while other decks of the targeted block may be in native mode (e.g., TLC/QLC/PLC mode). Advantageously, some examples may reduce a system requirement for spare blocks (e.g., reduce a number of required spare blocks on a NAND media) and help a storage system utilize the spare blocks more efficiently. Some examples may provide technology to mitigate disturbs in a hybrid deck SLC NAND memory configuration.

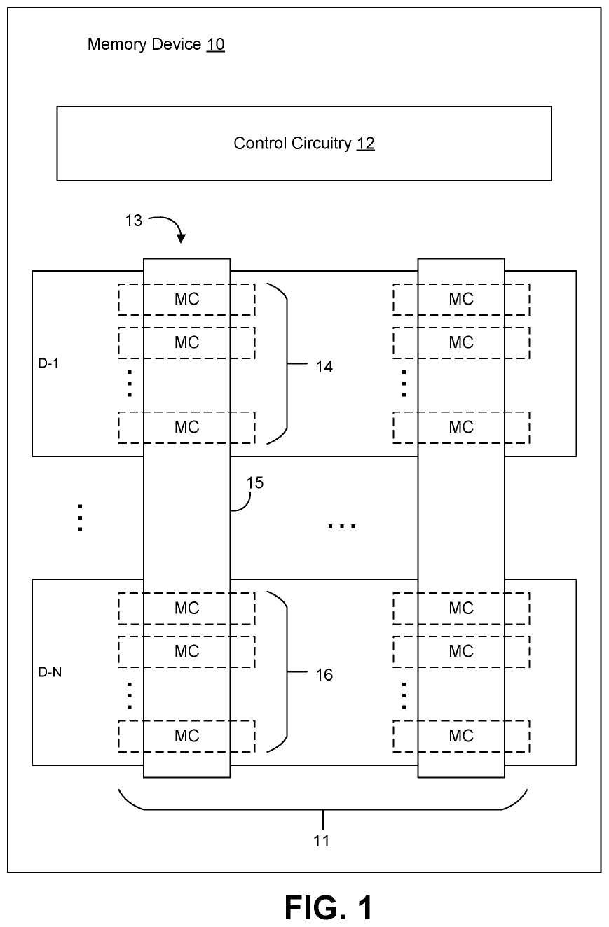

With reference to FIG. 1, an example of a memory device 10 may include NAND media 11 with a plurality of decks (e.g., deck D-1 through deck D-N, where N>1). The memory device 10 may further include control circuitry 12 coupled to the NAND media 11 to control access to a superblock 13 of memory cells 14 aligned along a pillar 15 of the NAND media 11. In some examples, the control circuitry 12 may be configured to provide bias voltages to the NAND media 11 to divide the NAND media 11 into the plurality of decks, each of which may be treated as independent, and to provide BBD operations on the NAND media 11. The control circuitry 12 may further include an output interface coupled to wordlines (WLs) of the NAND media 11. In examples, the control circuitry 12 may, in a deck erase operation, apply a first set of bias voltages via the interface to active WLs of a first deck of memory cells to be erased, and apply a second set of bias voltages via the interface to active WLs of one or more other decks of memory cells not to be erased, where the first set of bias voltages (on the memory cells to be erased) may be lower than the second set of bias voltages (on the memory cells not to be erased).

Similarly, in some examples, the control circuitry 12 may, in a deck program operation, apply a first set of bias voltages via the interface to active WLs of a first deck of memory cells to be programmed, and apply a second set of bias voltages via the interface to active WLs of one or more other decks of memory cells not to be programmed, where the first set of bias voltages (on the memory cells to be programmed) is higher than the second set of bias voltages (on the memory cells not to be programmed). The control circuitry 12 may respond to commands (e.g., from a processor or host) to perform memory operations of accessing a memory cell(s), such as a read operation to read information from memory cells and a write (e.g., programming) operation to store (e.g., program) information into memory cells. The control circuitry 12 may also perform an erase operation to clear information from some or all of memory cells. During various operations, the control circuitry 12 may cause various memory blocks (groups of memory cells) to be selected or deselected.

In some examples, as noted above, in order to operate each deck as an independent block, erase, program and read algorithms may perform the following processes: (i) erase one deck without disturbing the other decks; (ii) program one deck while the other decks are in various states (programmed, partially-programmed, or erased); (iii) program and erase one deck multiple times without disturbing the other decks; and (iv) read one deck while the other decks are in various states (programmed, partially-programmed, or erased).

In some examples, the superblock 13 may include at least a first block that may correspond to memory cells aligned along the pillar 15 in a first deck of the plurality of decks (e.g., memory cells 14 in D-1) and a second block that may correspond to memory cells aligned along the pillar 15 in a second deck of the plurality of decks (e.g., memory cells 16 in D-N). The circuitry 12 may also configure the NAND media 11 in a first program mode for the first block of the superblock 13, and configure the NAND media 11 in a second program mode for the second block of the superblock 13. In some examples, the control circuitry 12 may also configure the NAND media 11 in the second program mode for a third block of the superblock 13, where the third block corresponds to memory cells aligned along the pillar 15 in a third deck (not shown) of the plurality of decks. For example, the first program mode may be a SLC mode and the second program mode may be a native mode (e.g., TLC, QLC, PLC, etc.) of the NAND media 11.

In some examples, the first block may be to be reserved to store system-specific information, and the second block may be to be available to store general user data. In some examples, the control circuitry 12 may also configure the NAND media 11 in accordance with respective offsets for respective voltage settings for the first and second blocks. For example, the respective offsets may be selected to mitigate disturb between the decks in a hybrid deck SLC mode. The control circuitry 12 may also be configured to enforce/apply various of the NAND policies described herein. For example, the NAND media 11 may comprise 3D NAND memory cells such as floating gate NAND memory cells or charge trap flash (CTF) NAND memory cells.

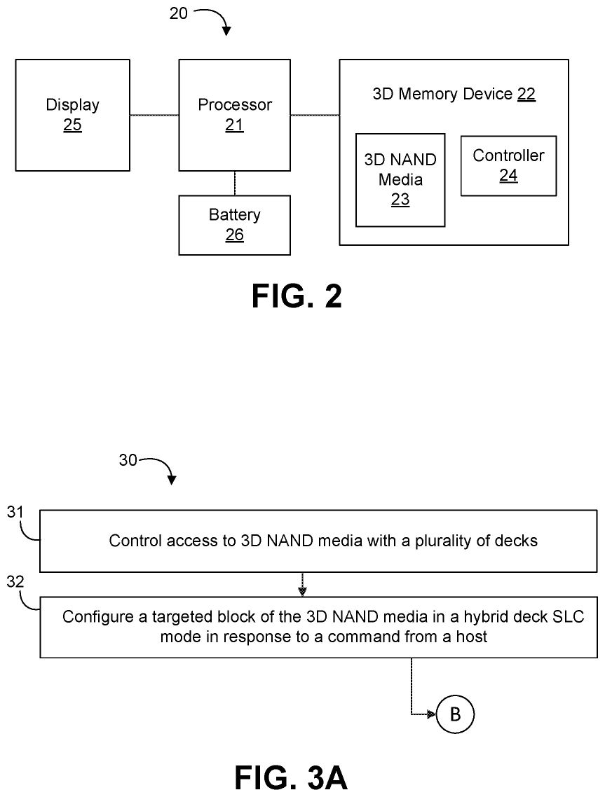

With reference to FIG. 2, an example of a system 20 may include a processor 21, and a 3D memory device 22 coupled with the processor 21, where the 3D memory device 22 is configured similar to the memory device 10. In particular, in the system 20 the 3D memory device 22 may include 3D NAND media 23 with a plurality of decks, and a controller 24 coupled to the 3D NAND media 23 to configure a first deck of the plurality of decks for a targeted block in a first program mode in response to a command that indicates the targeted block and the first deck, and configure a second deck of the plurality of decks for the targeted block in a second program mode in response to the command. In some examples, the controller 24 may be further configured to configure a third deck of the plurality of decks for the targeted block in the second program mode in response to the command. For example, the controller 24 may be configured to apply appropriate bias voltages to different physical wordlines of the 3D NAND media 23 in different combinations, such that the 3D NAND media 23 may be divided into two, three, four, or more decks, each of which may be treated as independent.

For example, the first program mode may be a SLC mode and the second program mode may be a native mode of the 3D NAND media 23. In some examples, the first deck of the targeted block and the second deck of the targeted block may be aligned along a pillar of the 3D NAND media 23. In some examples, the first deck of the targeted block may be to be reserved to store system-specific information. In some examples, the controller may be further to configure the first deck of the targeted block and the second deck of the targeted block in accordance with respective voltage setting offsets indicated by the command. For example, the command may correspond to a set feature command with a first parameter that indicates an offset profile and a second parameter that indicates an unselected deck status. In some examples, the system 20 may comprise a mobile computing device and may include any of a number of connected devices, peripherals, and/or components, such as at least one of a display 25 communicatively coupled to the processor 21, or a battery 26 coupled to the processor 21, etc.

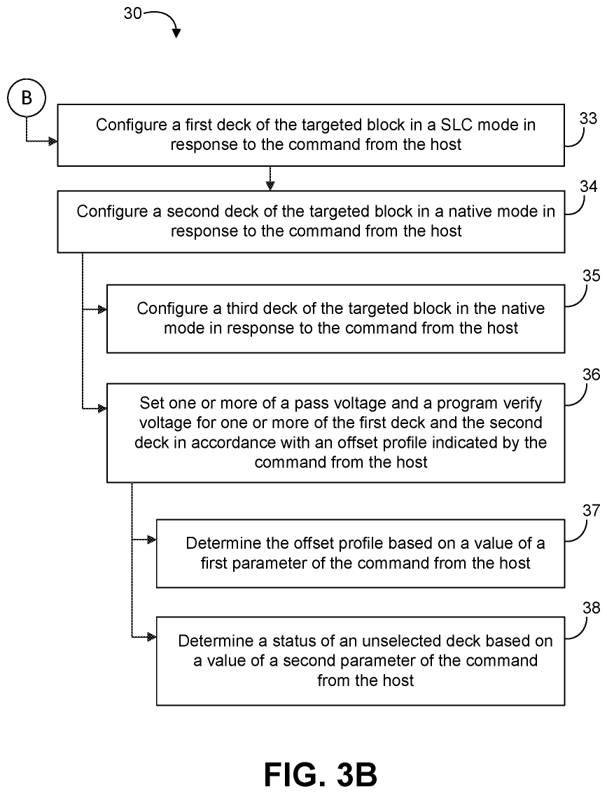

With reference to FIGS. 3A to 3B, an example of a method 30 may include controlling access to 3D NAND media with a plurality of decks at box 31, and configuring a targeted block of the 3D NAND media in a hybrid deck SLC mode in response to a command from a host at box 32. For example, the method 30 may include configuring a first deck of the targeted block in a SLC mode in response to the command from the host at box 33, and configuring a second deck of the targeted block in a native mode in response to the command from the host at box 34. The method 30 may also include configuring a third deck of the targeted block in the native mode in response to the command from the host at box 35.

In some examples, the method 30 may further include setting one or more of a pass voltage and a program verify voltage for one or more of the first deck and the second deck in accordance with an offset profile indicated by the command from the host at box 36. For example, the method 30 may include determining the offset profile based on a value of a first parameter of the command from the host at box 37, and/or determining a status of an unselected deck based on a value of a second parameter of the command from the host at box 38.

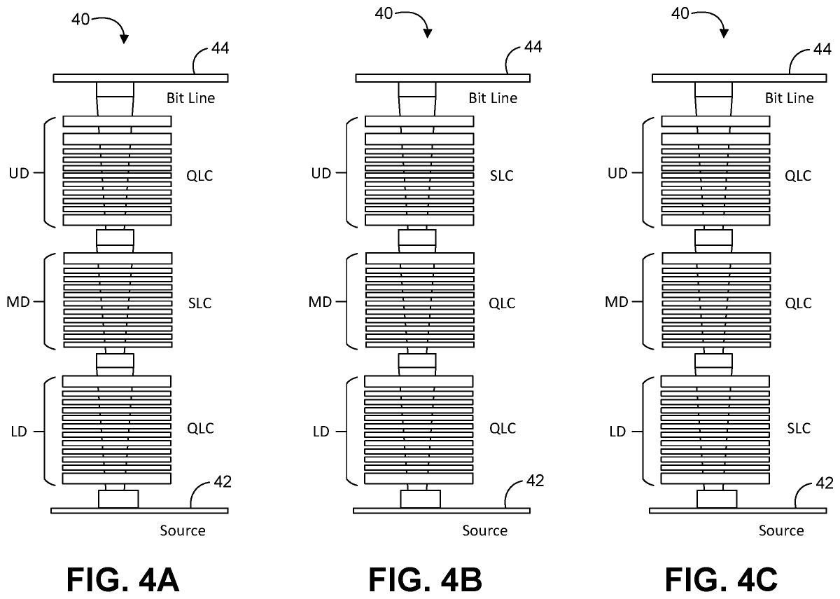

With reference to FIGS. 4A to 4C, examples of a memory device 40 include block-by-deck (BBD) technology. A NAND memory array may be three-dimensional (3D). For example, the memory array may include a plurality of memory cells stacked over one another. The memory cells may be stacked vertically or horizontally. Moreover, the memory cells may share a common channel region, such as one formed as a respective pillar of semiconductor material (e.g., polysilicon) about which the plurality of memory cells may be formed. A controller (not shown), may include any suitable technology configured to perform BBD erase, program, and read operations on the NAND memory array.

For example, a memory array of the memory device 40 may be a 3D NAND memory array, where NAND strings may extend substantially perpendicular to a plane 42 containing a common source and to a plane 44 containing bitlines (BLs) (e.g., where the plane 44 may be substantially parallel to the plane 42 containing the common source). Construction of the memory cells of the memory device 40 may include any suitable data-storage structure (e.g., a floating gate, charge trap, etc.) that maintains a data state of the cell (e.g., through changes in threshold voltage). In some cases, the memory cells may a control gate, a defined source, and/or a defined drain. For example, the memory cells have respective control gates connected to a WL.

In sensing (e.g., reading) a data state of a selected (e.g., target) memory cell, the memory cell is selectively activated in response to a particular voltage level applied to its control gate while current paths from the memory cell to the data line and to the source are established, thus permitting current flow, or lack thereof, between the data line and the source to indicate whether the memory cell has been activated in response to the particular voltage level applied to its control gate. For example, for a sensing operation of selected memory cell of a NAND string, a sense voltage (e.g., a read voltage or a verify voltage) may be applied to the control gate of memory cell while voltage levels are applied to the control gates of memory cells of the NAND string sufficient to activate those memory cells regardless of their data states, and while voltage levels are applied to the control gates of select transistors sufficient to activate those transistors. A sense operation that determines whether the memory cell is activated in response to one or more sense voltages may indicate one or more bits of the data state stored in that memory cell. In various examples, each memory cell can be programmed according to an SLC, MLC, TLC, a QLC, or other encoding scheme. Each cell's threshold voltage (Vt) is indicative of the data that is stored in the cell. Similarly, various program verify (PV) voltages may be applied to a memory cell during programming of the cell (e.g., during a program verify operation) to determine whether the threshold voltage of the cell has reached its desired level. In accordance with examples of hybrid deck SLC technology, offsets may be applied to the various voltages to mitigate disturb and the threshold voltage (Vt) shifts between the mixed decks.

Although various examples have been described with respect to a particular type of memory array (e.g., a NAND flash memory array), the teachings of the various examples may be equally applicable to any type of memory arrays (e.g., AND arrays, NOR arrays, etc.), including those recited herein or similar memory arrays.

As shown in FIGS. 4A to 4C, the memory device 40 includes three decks with an upper deck (UD), a middle deck (MD), and a lower deck (LD). In accordance with the hybrid SLC deck technology described herein, each of the decks vertically aligned along a pillar may correspond to a block of a superblock and one block of the superblock may be in SLC mode while the other blocks of the superblock may be in native mode (e.g., QLC in the illustrated example, but TLC, PLC, etc. in other examples). Any of the decks may be selected for the SLC mode. FIG. 4A shows the MD in SLC mode. FIG. 4B shows the UD in SLC mode. FIG. 4C shows the UD in SLC mode. Any suitable technology may be utilized to configure the selected deck in SLC mode. For example, the NAND media may support an on-the-fly (OTF) mode and examples of hybrid SLC deck feature may be supported with a dynamic SLC (dSLC) feature within the superblock to configure the selected deck in SLC mode, such that the NAND media may support the desired mix of SLC mode and native modes.

In some examples, a number of pages programmed for one deck which is in SLC Mode will vary from the other decks that are in native mode (e.g., IO traffic for a same superblock address may be less for the SLC block of the superblock as compared to the other blocks). Also, within the same superblock, an SLC prefix opcode may be utilized for array operations (e.g., read, program, erase, etc.) for the deck in SLC mode and while suitable other prefix opcodes may be utilized for the other decks. There may also be a program-time delta between the decks in the same superblock when the superblock is configured in the hybrid deck SLC mode.

To improve the utilization of hybrid SLC deck technology (e.g., to reduce read disturb between the mixed decks), various policies may be observed, implemented, and/or enforced at various levels of the system. At a datacenter system level, for example, a hybrid deck SLC mode (e.g., a mixed dSLC/native mode) within a plane/superblock level may be supported with a dSLC mode. In addition, within the superblock, a hybrid SLC deck policy may allow having only one deck in dSLC mode while other unselected decks within the superblock may need to be in either a native-mode or an erase dwell time control (EDTC) mode. In the hybrid Deck SLC mode, the hybrid SLC deck policy may allow having only one open deck per superblock. The policy may define an open deck as any of an erase (ERS) state, a partially erase state, or a partially program state. The policy may further indicate that no unselected deck within the superblock may receive more than a predefined number (e.g., sixty (60)) program/erase disturb cycles.

In accordance with some examples, a command interface may be implemented by a NAND controller that allows a host to send commands that cause the controller to configure various operational parameters/settings of the NAND memory device. In some examples, a NAND controller may implement an Open NAND Flash Interface (ONFI)-compatible command interface. For example, various specifications published at onfi.org describe set features commands with set features commands 80h through FFh reserved for vendor specific features.

In some examples, hybrid deck SLC technology may be implemented by configuring various internal NAND pass voltage (Vpass) and/or program verify (PV) voltages to reduce or minimize the disturb and the threshold voltage (Vt) shifts.

In some examples, one or more set feature commands, that may include vendor specific commands, may be utilized to provide information to the NAND controller. The NAND controller may then configure the memory device with appropriate Vpass/PV voltage settings in response to the set feature command(s). At a logical unit (LUN) level (e.g., for non-enhanced independent multi-plane read operation (non-eIMPRO), the vendor specific set feature command may be valid during a program algorithm only in a hybrid deck SLC mode (e.g., in all other modes the vendor specific set feature command is invalid).

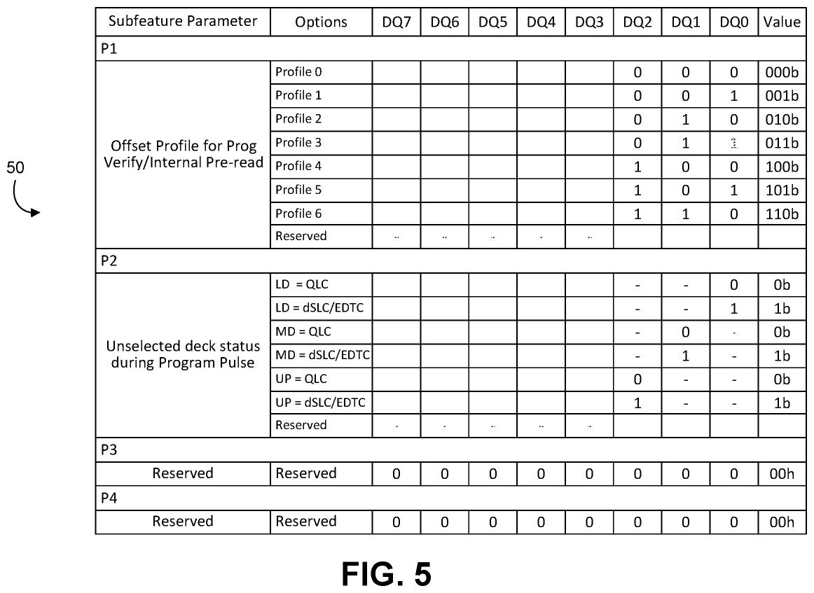

With reference to FIG. 5, an example table 50 shows how parameters that accompany a vendor specific hybrid deck SLC set feature command (e.g. Ftr_94h) may be utilized by a NAND controller to configure appropriate Vpass/PV voltage settings. A least significant three bits of a first parameter P1 (e.g., Ftr_94h_P1[2:0]; using set feature by LUN) may be utilized to choose a read offset profile offset during a PV section and an internal pre-read part of a program operation. For example, profile 0 may corresponds to zero offset and may be a default profile. A least significant three bits of a second parameter P2 (e.g., Ftr_94h_P2[2:0]) may be utilized to define the unselected deck status during a program pulse section of a program operation, where a value of one (1) may correspond to the indicated deck being in dSLC/EDTC mode while a value of zero (0) may correspond to the indicated deck being in native mode (e.g., QLC in table 50). A value of zero for P2 may be the default.

In some examples, the selected profile number (e.g. profile 0 through profile 6) corresponds to a set of voltage offsets to be applied to the various bias voltages for various BBD operations. For example, the profile number may index into a table or data structure that stores the various offsets to be applied to the applicable bias voltages. The number of offsets and the specific bias voltages may be different for the different operations. The amount of offset applied to each applicable bias voltage may be determined by any suitable technique, including empirically, that mitigates disturb and/or Vt shift for the applicable operation. During an operation, the NAND controller may apply the specified offset(s) to the applicable bias voltage(s).

In the case of read and eIMPRO operation for hybrid SLC superblocks, the vendor specific hybrid deck SLC set feature command (e.g., Ftr_94h) may not be applicable and the host may instead utilize other set feature commands to configure appropriate voltage settings. In the case where a selected deck is SLC, the host sets the parameters of the vendor specific hybrid deck SLC set feature command to zero (e.g., Ftr_94_P1,P2=0x00). In some examples, where a power loss algorithm direct to SLC operation is supported for SLC blocks (e.g., or a SLC deck), the NAND controller may ignore the vendor specific hybrid deck SLC set feature command (e.g., Ftr_94h) settings from the native programming set prior to the power loss event.

Another hybrid deck SLC policy may apply in a case where a host wants to transition an entire superblock from a hybrid deck SLC mode to an EDTC (DDD) mode. For this example EDTC (e.g., pre-program) policy for a datacenter system, 1) the host may transition any deck from hybrid Deck SLC mode to EDTC in any order; 2) each deck shall be fully erased before enabling EDTC mode; and 3) data on entire superblock is invalid at the start of the transition.

Another example EDTC (e.g., pre-program) policy for a datacenter system may apply in a case where the host wants to transition an entire superblock from EDTC to hybrid deck SLC mode. For this example policy applied to a three deck NAND memory device, 1) the host shall always start the transition from the LD and follow the order of LD, then MD, and then UD; and 2) the host shall ensure that only one deck in the superblock can be in SLC mode.

Another example EDTC (e.g., pre-program) policy for a datacenter system may apply in a case where the host wants only one deck in the EDTC mode (e.g., during program fail, abort, reset, partial deck, etc.). For this example policy, 1) the NAND shall support a capability to EDTC one deck (e.g., an data is considered valid in the other decks); and 2) erase/program on an unselected deck is not supported (e.g., the host shall erase/program the EDTC deck first). A vendor may provide a user with details of the various NAND policy rules that the system needs to follow to operate in hybrid deck SLC mode.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

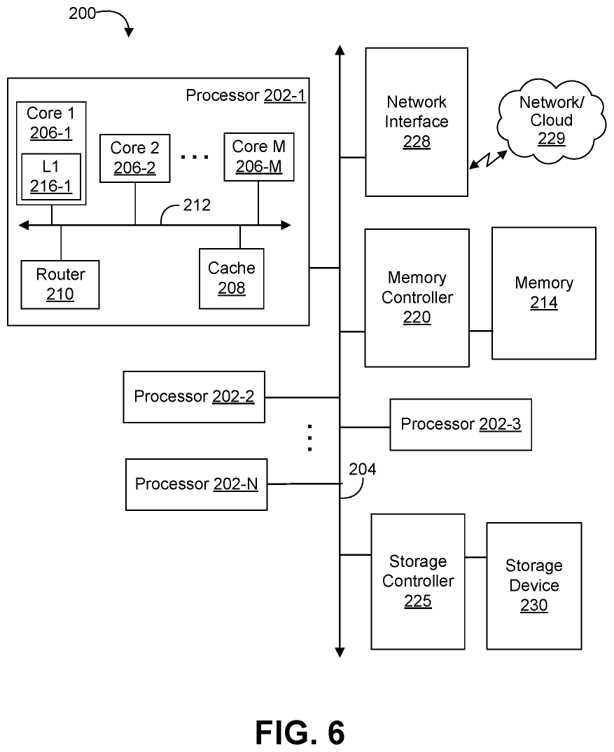

Turning now to FIG. 6, an example of a computing system 200 may include one or more processors 202-1 through 202-N (generally referred to herein as “processors 202” or “processor 202”). The processors 202 may communicate via an interconnection or bus 204. Each processor 202 may include various components some of which are only discussed with reference to processor 202-1 for clarity. Accordingly, each of the remaining processors 202-2 through 202-N may include the same or similar components discussed with reference to the processor 202-1.

In some examples, the processor 202-1 may include one or more processor cores 206-1 through 206-M (referred to herein as “cores 206,” or more generally as “core 206”), a cache 208 (which may be a shared cache or a private cache in various examples), and/or a router 210. The processor cores 206 may be implemented on a single integrated circuit (IC) chip. Moreover, the chip may include one or more shared and/or private caches (such as cache 208), buses or interconnections (such as a bus or interconnection 212), memory controllers, or other components.

In some examples, the router 210 may be used to communicate between various components of the processor 202-1 and/or system 200. Moreover, the processor 202-1 may include more than one router 210. Furthermore, the multitude of routers 210 may be in communication to enable data routing between various components inside or outside of the processor 202-1.

The cache 208 may store data (e.g., including instructions) that is utilized by one or more components of the processor 202-1, such as the cores 206. For example, the cache 208 may locally cache data stored in a memory 214 for faster access by the components of the processor 202. As shown in FIG. 6, the memory 214 may be in communication with the processors 202 via the interconnection 204. In some examples, the cache 208 (that may be shared) may have various levels, for example, the cache 208 may be a mid-level cache and/or a last-level cache (LLC). Also, each of the cores 206 may include a level 1 (L1) cache (216-1) (generally referred to herein as “L1 cache 216”). Various components of the processor 202-1 may communicate with the cache 208 directly, through a bus (e.g., the bus 212), and/or a memory controller or hub.

As shown in FIG. 6, memory 214 may be coupled to other components of system 200 through a memory controller 220. Memory 214 may include volatile memory and may be interchangeably referred to as main memory or system memory. Even though the memory controller 220 is shown to be coupled between the interconnection 204 and the memory 214, the memory controller 220 may be located elsewhere in system 200. For example, memory controller 220 or portions of it may be provided within one of the processors 202 in some examples. Alternatively, memory 214 may include byte-addressable non-volatile memory such as INTEL OPTANE technology.

The system 200 may communicate with other devices/systems/networks via a network interface 228 (e.g., which is in communication with a computer network and/or the cloud 229 via a wired or wireless interface). For example, the network interface 228 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 229.

System 200 may also include a storage device such as a storage device 230 coupled to the interconnect 204 via storage controller 225. Hence, storage controller 225 may control access by various components of system 200 to the storage device 230. Furthermore, even though storage controller 225 is shown to be directly coupled to the interconnection 204 in FIG. 6, storage controller 225 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), Serial Attached SCSI (SAS), Fiber Channel, etc.) with one or more other components of system 200 (for example where the storage bus is coupled to interconnect 204 via some other logic like a bus bridge, chipset, etc.) Additionally, storage controller 225 may be incorporated into memory controller logic or provided on a same integrated circuit (IC) device in various examples (e.g., on the same circuit board device as the storage device 230 or in the same enclosure as the storage device 230).

Furthermore, storage controller 225 and/or storage device 230 may be coupled to one or more sensors (not shown) to receive information (e.g., in the form of one or more bits or signals) to indicate the status of or values detected by the one or more sensors. These sensor(s) may be provided proximate to components of system 200 (or other computing systems discussed herein), including the cores 206, interconnections 204 or 212, components outside of the processor 202, storage device 230, SSD bus, SATA bus, storage controller 225, etc., to sense variations in various factors affecting power/thermal behavior of the system/platform, such as temperature, operating frequency, operating voltage, power consumption, and/or inter-core communication activity, etc. Any of the memory and/or storage devices in the system 200 may include the 3D memory with hybrid deck SLC technology as described herein.

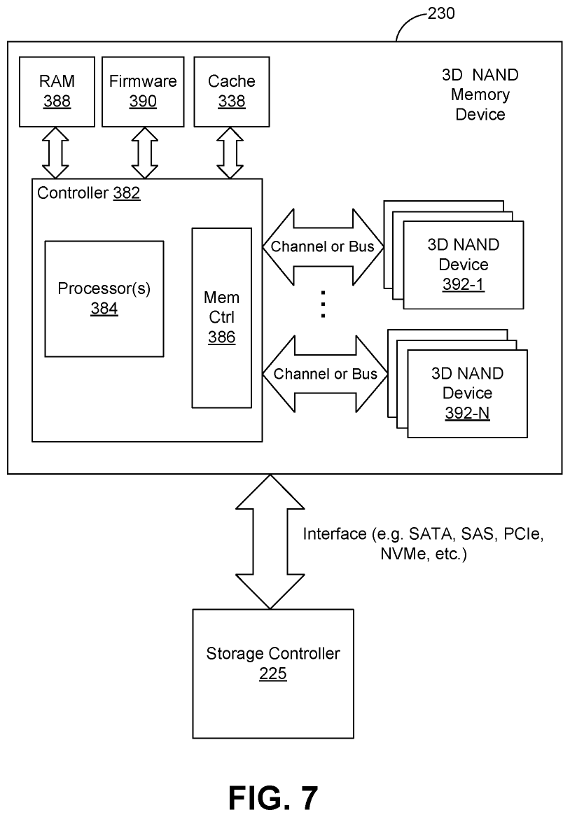

FIG. 7 illustrates a block diagram of various components of an example storage device 230, according to an example. As illustrated in FIG. 7, the storage device 230 may be a 3D NAND memory device that includes a controller 382 (which in turn includes one or more processor cores or processors 384 and memory controller logic 386), cache 338, RAM 388, firmware storage 390, and one or more 3D NAND memory device 392-1 to 392-N (collectively 3D NAND media 392). The 3D NAND media 392 is coupled to the memory controller logic 386 via one or more memory channels or busses. Also, device 230 communicates with the storage controller 225 via an interface (such as a SATA, SAS, PCIe, NVMe, etc., interface). Processors 384 and/or controller 382 may compress/decompress data written to or read from 3D NAND memory device 392-1 to 392-N.

One or more of the features/aspects/operations discussed with reference to FIGS. 1-5 may be performed by one or more of the components of FIG. 7. Also, one or more of the features/aspects/operations of FIGS. 1-5 may be programmed into the firmware 390. Further, the storage controller 225 may also various aspects of the hybrid deck SLC technology (e.g., sending the vendor specific hybrid deck SLC commands, implement/enforce various host side NAND policies, etc.).

In some examples, the controller 382 may be configured to respond to commands from the storage controller 225. The controller 382 may respond to general commands to read, write, and erase the 3D NAND media 392 (e.g., including BBD operations) and also to vendor specific commands for hybrid deck SLC technology. For example, the controller 382 may configure a targeted block of the 3D NAND media 392 in a hybrid deck SLC mode in response to a vendor specific command from the storage controller 225, configure a first deck of the targeted block in a SLC mode in response to the vendor specific command from the storage controller 225, configure a second deck of the targeted block in a native mode in response to the vendor specific command from the storage controller 225, configure a third deck of the targeted block in the native mode in response to the vendor specific command from the storage controller 225, set one or more of a pass voltage and a program verify voltage for one or more of the first deck and the second deck in accordance with an offset profile indicated by the vendor specific command from the storage controller 225, determine the offset profile based on a value of a first parameter of the vendor specific command from the storage controller 225, and/or determine a status of an unselected deck based on a value of a second parameter of the vendor specific command from the storage controller 225.

### Additional Notes and Examples

Example 1 includes a memory device, comprising NAND media with a plurality of decks, and circuitry coupled to the NAND media to control access to a superblock of memory cells aligned along a pillar of the NAND media, wherein the superblock includes at least a first block that corresponds to memory cells aligned along the pillar in a first deck of the plurality of decks and a second block that corresponds to memory cells aligned along the pillar in a second deck of the plurality of decks, configure the NAND media in a first program mode for the first block of the superblock, and configure the NAND media in a second program mode for the second block of the superblock.

Example 2 includes the memory device of Example 1, wherein the circuitry is further to configure the NAND media in the second program mode for a third block of the superblock, wherein the third block corresponds to memory cells aligned along the pillar in a third deck of the plurality of decks.

Example 3 includes the memory device of any of Examples 1 to 2, wherein the first program mode is a single-level cell mode and wherein the second program mode is a native mode of the NAND media.

Example 4 includes the memory device of any of Examples 1 to 3, wherein the first block is to be reserved to store system-specific information.

Example 5 includes the memory device of Example 4, wherein the second block is to be available to store general user data.

Example 6 includes the memory device of any of Examples 1 to 5, wherein the circuitry is further to configure the NAND media in accordance with respective offsets for respective voltage settings for the first and second blocks.

Example 7 includes the memory device of any of Examples 1 to 6, wherein the NAND media comprises three-dimensional NAND memory cells.

Example 8 includes a system, comprising a processor, and a three-dimensional (3D) memory device coupled with the processor, wherein the 3D memory device includes 3D NAND media with a plurality of decks, and a controller coupled to the 3D NAND media to configure a first deck of the plurality of decks for a targeted block in a first program mode in response to a command that indicates the targeted block and the first deck, and configure a second deck of the plurality of decks for the targeted block in a second program mode in response to the command.

Example 9 includes the system of Example 8, wherein the controller is further to configure a third deck of the plurality of decks for the targeted block in the second program mode in response to the command.

Example 10 includes the system of any of Examples 8 to 9, wherein the first program mode is a single-level cell mode and wherein the second program mode is a native mode of the 3D NAND media.

Example 11 includes the system of any of Examples 8 to 10, wherein the first deck of the targeted block and the second deck of the targeted block are aligned along a pillar of the 3D NAND media.

Example 12 includes the system of any of Examples 8 to 11, wherein the first deck of the targeted block is to be reserved to store system-specific information.

Example 13 includes the system of any of Examples 8 to 12, wherein the controller is further to configure the first deck of the targeted block and the second deck of the targeted block in accordance with respective voltage setting offsets indicated by the command.

Example 14 includes the system of Example 13, wherein the command corresponds to a set feature command with a first parameter that indicates an offset profile and a second parameter that indicates an unselected deck status.

Example 15 includes a method, comprising controlling access to three-dimensional (3D) NAND media with a plurality of decks, and configuring a targeted block of the 3D NAND media in a hybrid deck single-level cell (SLC) mode in response to a command from a host.

Example 16 includes the method of Example 15, further comprising configuring a first deck of the targeted block in a SLC mode in response to the command from the host, and configuring a second deck of the targeted block in a native mode in response to the command from the host.

Example 17 includes the method of Example 16, further comprising configuring a third deck of the targeted block in the native mode in response to the command from the host.

Example 18 includes the method of any of Examples 16 to 17, further comprising setting one or more of a pass voltage and a program verify voltage for one or more of the first deck and the second deck in accordance with an offset profile indicated by the command from the host.

Example 19 includes the method of Example 18, further comprising determining the offset profile based on a value of a first parameter of the command from the host.

Example 20 includes the method of any of Examples 18 to 19, further comprising determining a status of an unselected deck based on a value of a second parameter of the command from the host.

Example 21 includes an apparatus, comprising means for controlling access to three-dimensional (3D) NAND media with a plurality of decks, and means for configuring a targeted block of the 3D NAND media in a hybrid deck single-level cell (SLC) mode in response to a command from a host.

Example 22 includes the method of Example 21, further comprising means for configuring a first deck of the targeted block in a SLC mode in response to the command from the host, and means for configuring a second deck of the targeted block in a native mode in response to the command from the host.

Example 23 includes the method of Example 22, further comprising means for configuring a third deck of the targeted block in the native mode in response to the command from the host.

Example 24 includes the method of any of Examples 22 to 23, further comprising means for setting one or more of a pass voltage and a program verify voltage for one or more of the first deck and the second deck in accordance with an offset profile indicated by the command from the host.

Example 25 includes the method of Example 24, further comprising means for determining the offset profile based on a value of a first parameter of the command from the host.

Example 26 includes the method of any of Examples 24 to 25, further comprising means for determining a status of an unselected deck based on a value of a second parameter of the command from the host.

Example 27 includes at least one non-transitory one machine readable medium comprising a plurality of instructions that, in response to being executed on a computing device, cause the computing device to control access to three-dimensional (3D) NAND media with a plurality of decks, and configure a targeted block of the 3D NAND media in a hybrid deck single-level cell (SLC) mode in response to a command from a host.

Example 28 includes the at least one non-transitory one machine readable medium of Example 27, comprising a plurality of further instructions that, in response to being executed on the computing device, cause the computing device to configure a first deck of the targeted block in a SLC mode in response to the command from the host, and configure a second deck of the targeted block in a native mode in response to the command from the host.

Example 29 includes the at least one non-transitory one machine readable medium of Example 28, comprising a plurality of further instructions that, in response to being executed on the computing device, cause the computing device to configure a third deck of the targeted block in the native mode in response to the command from the host.

Example 30 includes the at least one non-transitory one machine readable medium of any of Examples 28 to 29, comprising a plurality of further instructions that, in response to being executed on the computing device, cause the computing device to set one or more of a pass voltage and a program verify voltage for one or more of the first deck and the second deck in accordance with an offset profile indicated by the command from the host.

Example 31 includes the at least one non-transitory one machine readable medium of Example 30, comprising a plurality of further instructions that, in response to being executed on the computing device, cause the computing device to determine the offset profile based on a value of a first parameter of the command from the host.

Example 32 includes the at least one non-transitory one machine readable medium of any of Examples 30 to 31, comprising a plurality of further instructions that, in response to being executed on the computing device, cause the computing device to determine a status of an unselected deck based on a value of a second parameter of the command from the host.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various examples may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one example may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the examples are not limited to the examples so described, but can be practiced with modification and alteration without departing from the scope of the appended claims. For example, the above examples may include specific combination of features. However, the above examples are not limited in this regard and, in various implementations, the above examples may include the undertaking only a subset of such features, undertaking a different order of such features, undertaking a different combination of such features, and/or undertaking additional features than those features explicitly listed. The scope of the examples should, therefore, be determined with reference to the appended claims, along with the full scope of equivalents to which such claims are entitled.

What is claimed is:

1. A memory device, comprising:
NAND media with a plurality of decks; and
circuitry coupled to the NAND media to:
control access to a superblock of memory cells aligned along a pillar of the NAND media, wherein the superblock includes at least a first block that corresponds to memory cells aligned along the pillar in a first deck of the plurality of decks and a second block that corresponds to memory cells aligned along the pillar in a second deck of the plurality of decks;
configure the NAND media in a first program mode for the first block of the superblock; and
configure the NAND media in a second program mode for the second block of the superblock.

2. The memory device of claim 1, wherein the circuitry is further to:
configure the NAND media in the second program mode for a third block of the superblock, wherein the third block corresponds to memory cells aligned along the pillar in a third deck of the plurality of decks.

3. The memory device of claim 1, wherein the first program mode is a single-level cell mode and wherein the second program mode is a native mode of the NAND media.

4. The memory device of claim 1, wherein the first block is to be reserved to store system-specific information.

5. The memory device of claim 4, wherein the second block is to be available to store general user data.

6. The memory device of claim 1, wherein the circuitry is further to configure the NAND media in accordance with respective offsets for respective voltage settings for the first and second blocks.

7. The memory device of claim 1, wherein the NAND media comprises three-dimensional NAND memory cells.

8. A system, comprising:
a processor; and
a three-dimensional (3D) memory device coupled with the processor, wherein the 3D memory device includes 3D NAND media with a plurality of decks, and a controller coupled to the 3D NAND media to:
configure a first deck of the plurality of decks for a targeted block in a first program mode in response to a command that indicates the targeted block and the first deck, and
configure a second deck of the plurality of decks for the targeted block in a second program mode in response to the command.

9. The system of claim 8, wherein the controller is further to:
configure a third deck of the plurality of decks for the targeted block in the second program mode in response to the command.

10. The system of claim 8, wherein the first program mode is a single-level cell mode and wherein the second program mode is a native mode of the 3D NAND media.

11. The system of claim 8, wherein the first deck of the targeted block and the second deck of the targeted block are aligned along a pillar of the 3D NAND media.

12. The system of claim 8, wherein the first deck of the targeted block is to be reserved to store system-specific information.

13. The system of claim 8, wherein the controller is further to:
configure the first deck of the targeted block and the second deck of the targeted block in accordance with respective voltage setting offsets indicated by the command.

14. The system of claim 13, wherein the command corresponds to a set feature command with a first parameter that indicates an offset profile and a second parameter that indicates an unselected deck status.

15. A method, comprising:
controlling access to three-dimensional (3D) NAND media with a plurality of decks; and
configuring a targeted block of the 3D NAND media in a hybrid deck single-level cell (SLC) mode in response to a command from a host.

16. The method of claim 15, further comprising:
configuring a first deck of the targeted block in a SLC mode in response to the command from the host; and
configuring a second deck of the targeted block in a native mode in response to the command from the host.

17. The method of claim 16, further comprising:
configuring a third deck of the targeted block in the native mode in response to the command from the host.

18. The method of claim 16, further comprising:
setting one or more of a pass voltage and a program verify voltage for one or more of the first deck and the second deck in accordance with an offset profile indicated by the command from the host.

19. The method of claim 18, further comprising:
determining the offset profile based on a value of a first parameter of the command from the host.

20. The method of claim 19, further comprising:
determining a status of an unselected deck based on a value of a second parameter of the command from the host.
